(19) United States
(12) Patent Application Publication
(10) Pub. No.: US 2006/0027097 A1
(43) Pub. Date: Feb. 9, 2006

(54) Composite piston for electromagnetic induction type reciprocating pump

(76) Inventor: Pao Chen Lee, Yung Kang City (TW)

Correspondence Address: CHARLES E. BAXLEY, ESQ., 90 JOHN STREET, THIRD FLOOR, NEW YORK, NY, 10038, US

(21) Appl. No.: 10/910,719

(22) Filed: Aug. 3, 2004

(51) Int. Cl. F16J 1/00

(52) U.S. Cl. 92/255

(57) ABSTRACT

A composite piston for an electromagnetic induction type reciprocating pump includes a metal attraction block and a metal tube. The attraction block includes a central through-hole and a pressure relief port communicated with the central through-hole. The attraction block further includes an end to which the metal tube is securely engaged. The end of the attraction block includes an engaging hole having an inner diameter corresponding to an outer diameter of the metal tube. The metal tube has an end received in the engaging hole of the attraction block and bonded with the attraction block by welding.

### BACKGROUND OF THE INVENTION

1. Field of the Invention

The present invention relates to a piston for a pump. In particular, the present invention relates to a composite piston for an electromagnetic induction type reciprocating pump.

2. Description of the Related Art

An electromagnetic induction type reciprocating pump is generally used in household appliances, such as a water feeding device of a high-pressure coffee maker. FIG. 4 of the drawings illustrates a typical conventional electromagnetic induction type reciprocating pump comprising a cylinder 1′, a piston 2′ received in the cylinder 1′, two elastic elements 3′ and 4′ respectively mounted on two sides of the piston 2′, and an electromagnetic device 5′ mounted around the cylinder 1′. The electromagnetic device 5′ includes a diode (not shown) to create intermittent magnetic attractive force for the electromagnetic device 5′. Mounted in front of the piston 2′ are an elastic element 6′ and a ball 7′ pressing against an outer end of the piston 2′. An O-ring 8′ provides required sealing.

The piston 2′ is obtained by means of lathing a magnetically conductive metal rod. The piston 2′ includes an attraction portion 21′ having an outer diameter slightly smaller than an inner diameter of the cylinder 1′. The attraction portion 21′ includes a central through-hole 211′ with a pressure relief port 212′ communicated with the central through-hole 211′. The piston 2′ further includes a tubular portion 22′ having an outer diameter slightly smaller than an opening 11′ in an end of the cylinder 1′. When the electromagnetic device 5′ operates, the attraction portion 21′ of the piston 2′ is attracted and thus reciprocatingly moves in the cylinder 1′. Water entering the cylinder 1′ via a side of the cylinder 1′ is pressurized and then outputted via the tubular portion 22′.

The electromagnetic inductive type reciprocating pump operates smoothly while preventing leakage of the cylinder 1′. However, the outer diameter of the tubular portion 22′ of the piston 2′ must have a high precision (or low tolerance), which is costly for lathing. Further, lathing tends to create a larger tolerance of the product in addition to generation of waste material, leading to an increase in the cost and to waste of material.

Injection molding has been proposed to replace lathing, yet raw material error, formation temperature, formation pressure, mold, etc still result in large tolerance.

### SUMMARY OF THE INVENTION

In accordance with a first aspect of the present invention, a composite piston for an electromagnetic induction type reciprocating pump comprises a metal attraction block and a metal tube. The attraction block includes a central through-hole and a pressure relief port communicated with the central through-hole. The attraction block further includes an end to which the metal tube is securely engaged.

The metal tube is processed by precision finishing. The metal tube is with or without a seam.

The end of the attraction block includes an engaging hole having an inner diameter corresponding to an outer diameter of the metal tube. The metal tube has an end received in the engaging hole of the attraction block and bonded with the attraction block by welding.

Other objectives, advantages, and novel features of the invention will become more apparent from the following detailed description when taken in conjunction with the accompanying drawings.

### BRIEF DESCRIPTION OF THE DRAWINGS

FIG. 1 is an exploded perspective view of a composite piston for an electromagnetic induction type reciprocating pump in accordance with the present invention.

FIG. 2 is a perspective view of the composite piston in accordance with the present invention.

FIG. 3 is a sectional view of the composite piston in accordance with the present invention.

FIG. 4 is a sectional view of a conventional electromagnetic induction type reciprocating pump.

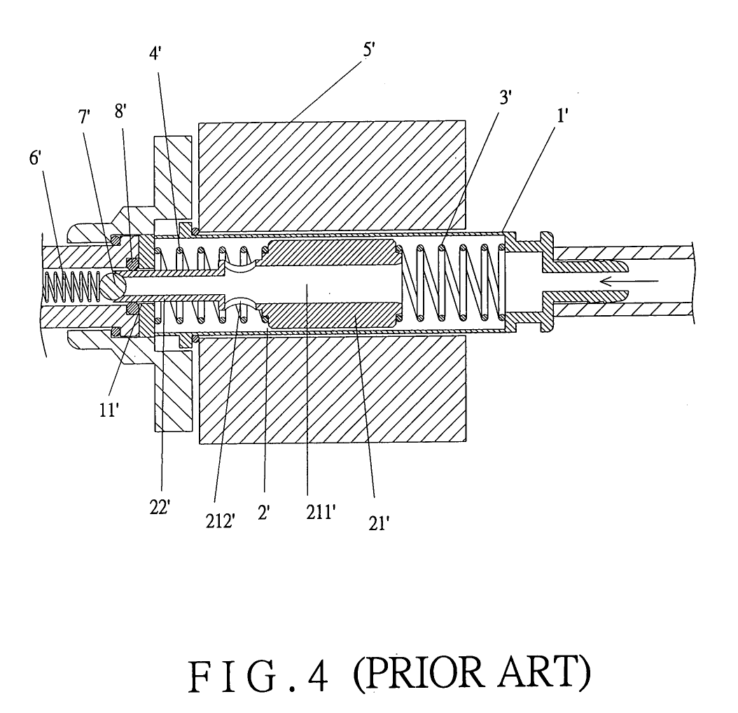

### DETAILED DESCRIPTION OF THE PREFERRED EMBODIMENT

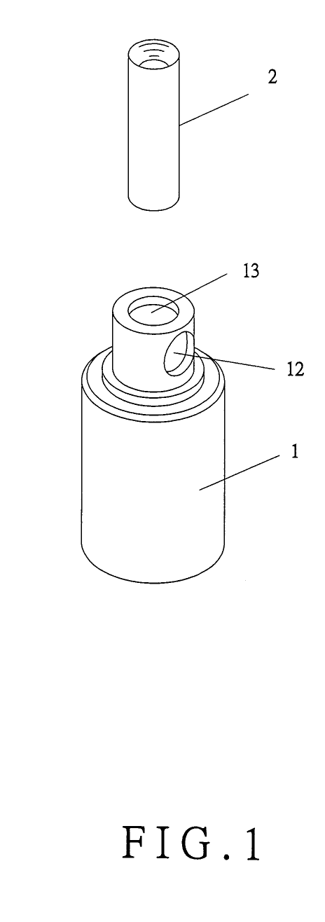

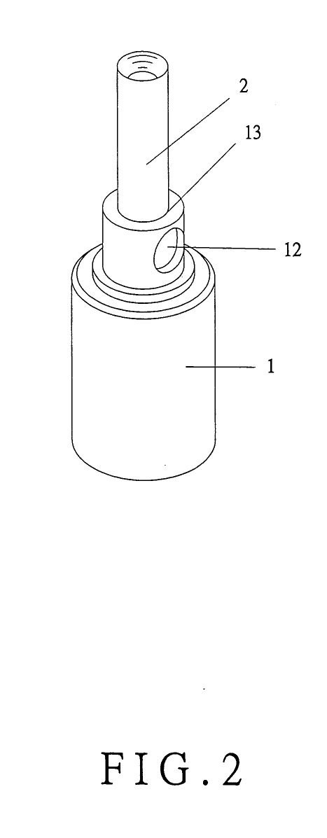

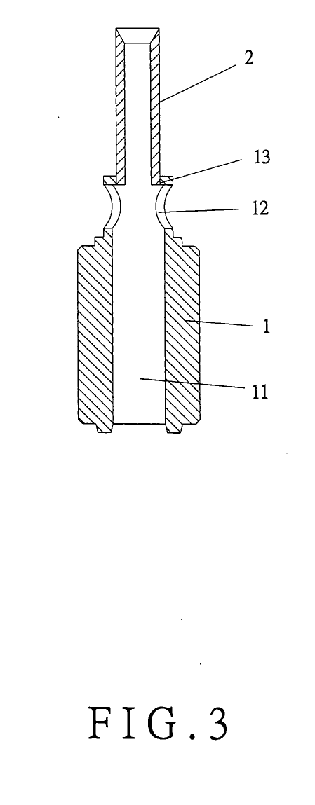

Referring to FIGS. 1 through 3, a composite piston for an electromagnetic induction type reciprocating pump in accordance with the present invention comprises a metal attraction block 1 and a metal tube 2. The attraction block 1 includes a central through-hole 11 and a pressure relief port 12 communicated with the central through-hole 11. An end of the attraction block 1 includes an engaging hole 13 for engaging with the metal tube 2.

The metal tube 2 is a tube with or without a seam and processed by precision finishing. The metal tube 2 includes an outer diameter corresponding to an inner diameter of the engaging hole 13 of the attraction block 1. An end of the metal tube 2 is placed in the engaging hole 13 of the attraction block 1 and then bonded to the attraction block 1 by welding.

The metal tube 2 can be processed by coreless grinding to have a precise outer diameter. Precise processing of the metal tube 2 can be achieved. Metal tubes with or without a seam available on the market have a precise outer diameter and can be obtained at a low cost. These metal tubes can be used in the composite piston in accordance with the present invention. Thus, a piston with high precision and smooth operation can be obtained while avoiding waste of material.

Although a specific embodiment has been illustrated and described, numerous modifications and variations are still possible without departing from the essence of the invention. The scope of the invention is limited by the accompanying claims.

What is claimed is:

1. A composite piston for an electromagnetic induction type reciprocating pump comprising a metal attraction block and a metal tube, the attraction block including a central through-hole and a pressure relief port communicated with the central through-hole, the attraction block further including an end to which the metal tube is securely engaged.

2. The composite piston for an electromagnetic induction type reciprocating pump as claimed in claim 1 wherein the metal tube is processed by precision finishing.

3. The composite piston for an electromagnetic induction type reciprocating pump as claimed in claim 2 wherein the metal tube has a seam.

4. The composite piston for an electromagnetic induction type reciprocating pump as claimed in claim 2 wherein the metal tube is seamless.

5. The composite piston for an electromagnetic induction type reciprocating pump as claimed in claim 1 wherein the end of the attraction block includes an engaging hole having an inner diameter corresponding to an outer diameter of the metal tube, and wherein the metal tube has an end received in the engaging hole of the attraction block and bonded with the attraction block by welding.
